(19) United States
(12) Patent Application Publication
(10) Pub. No.: US 2009/0049725 A1
(43) Pub. Date: Feb. 26, 2009

(54) Display device

(76) Inventors: Norlene Gensler, Baltimore, MD (US); David Pomerantz, Lutherville, MD (US)

Correspondence Address: JAMES RAY & ASSOCIATES, 2640 PITCAIRN ROAD, MONROEVILLE, PA, 15146, US

(21) Appl. No.: 12/229,439

(22) Filed: Aug. 22, 2008

Related U.S. Application Data
(60) Provisional application No. 60/966,189, filed on Aug. 24, 2007.

(51) Int. Cl. G09F 7/18

(52) U.S. Cl. 40/657; 40/1

(57) ABSTRACT

A display device includes a back-board type member and a support mechanism engageable thereto. A plurality of mounting rails are releasably securable to such back-board type member on at least one of a front side, a back side, and a combination thereof such that each rail runs at least one of side to side and top to bottom across such back-board type member. A securing mechanism has a first portion engageable with such back-board type member and a second portion engageable with such plurality of mounting rails for releasably securing such mounting rails to such back-board type member such that at least a predetermined portion of at least one predetermined item may at least one of sit on at least a portion of at least one of such mounting rails, releasably slide behind at least a portion of at least one of such mounting rails and a combination thereof.

### CROSS REFERENCE TO RELATED APPLICATION

This patent application is related to and claims priority from U.S. Provisional Patent Application Ser. No. 60/966,189 filed Aug. 24, 2007.

### FIELD OF THE INVENTION

The present invention relates, in general, to display devices for holding and displaying items such as escort cards, place cards, name tags, name badges, badges, seating arrangement cards, instructional cards, index cards, photographs, greeting cards, and the like.

### BACKGROUND OF THE INVENTION

Prior to the conception and development of the present invention, escort cards, place cards, name tags, name badges, badges, seating arrangement cards, instructional cards, index cards, photographs, greeting cards, and the like, as are generally well known in the prior art, have been used for various purposes. These types of items are generally placed on a table and as people walk past the table they pick up their particular item. Unfortunately, such items can get lost, may fall behind such table or on the floor, and are often presented in a disorderly fashion. Furthermore, because the height of such table is usually meant for sitting at, not standing at, people often have difficulty locating their escort cards, place cards, name tags, name badges, badges, seating arrangement cards, instructional cards, index cards, photographs, greeting cards, and the like. Therefore, there is a need for a device which can be utilized to present such items in a more visible and organized manner.

Specifically of interest to the present invention are the following: Lean, et al, U.S. Pat. No. 561,231, discloses an advertising or bulletin board which includes a series of pockets formed by grooving cleats in their opposite sides and reversible signs or slats interchangeably and removably fitted in the pockets. The signs or slats are held in place by a strip common to all which closed the open ends of the pockets. The device is primarily meant for display prices of predetermined items.

Fogarty, U.S. Design Pat. No. D62,481, discloses an ornamental design for a holder of signs. Such device appears to be a device which would hold a name sign, such as would fit on a person's desk and would indicate his or her profession or job title.

Bonnell, U.S. Design Pat. No. D115,247, discloses the ornamental design for a molding strip.

Fisher, U.S. Design Pat. No. D202,759, discloses the ornamental design for a card display holder. Such card display holder appears to be meant for holding cards indicating prices of predetermined items.

Silverman, U.S. Pat. No. 3,896,575, discloses a device including a flexible transparent sheet of plastic having contoured portions for receiving elongated plastic or paper strips printed with predetermined information, such elongated strips slide within the contoured portion with print visible through such transparent sheet of plastic.

### SUMMARY OF THE INVENTION

The present invention provides a display device. Such display device includes a back-board type member manufactured from a first predetermined material and having a first predetermined shape and a first predetermined size. A support means is engageable with such back-board type member for supporting such back-board type member. A plurality of mounting rails are releasably securable to such back-board type member on at least one of a front side of such backboard type member, a backside of such backboard type member, and a combination thereof such that each of such plurality of mounting rails runs at least one of side to side and top to bottom across such back-board type member. Such mounting rails are manufactured from a second predetermined material and have a second predetermined size and a second predetermined shape. A securing means has a first portion engageable with such back-board type member and a second portion engageable with such plurality of mounting rails for releasably securing such mounting rails to such back-board type member at a predetermined location thereon such that at least a predetermined portion of at least one predetermined item may at least one of sit on at least a portion of at least one of such mounting rails, releasably slide behind at least a portion of at least one of such mounting rails and a combination thereof.

According to another embodiment a method of displaying at least one of escort cards, place cards, name tags, name badges, badges, seating arrangement cards, instructional cards, index cards, photographs, greeting cards, and a combination thereof is provided. Such method includes the steps of providing a display device including; a back-board type member manufactured from a first predetermined material and having a first predetermined shape and a first predetermined size, a support means engageable with such back-board type member for supporting such back-board type member, a plurality of mounting rails releasably securable to such back-board type member on at least one of a front side of such backboard type member, a backside of such backboard type member, and a combination thereof such that each of such plurality of mounting rails runs at least one of side to side and top to bottom across such back-board type member, such mounting rails being manufactured from a second predetermined material and having a second predetermined size and a second predetermined shape, a securing means having a first portion engageable with such back-board type member and a second portion engageable with such plurality of mounting rails for releasably securing such mounting rails to such back-board type member at a predetermined location thereon such that at least a predetermined portion of at least one predetermined item may at least one of sit on at least a portion of at least one of such mounting rails, releasably slide behind at least a portion of at least one of such mounting rails and a combination thereof. Placing at least a portion of at least one of such escort cards, place cards, such name tags, such name badges, such badges, such seating arrangement cards, such instructional cards, such index cards, such photographs, such greeting cards, and a combination thereof at least one of on at least a portion of at least one of such mounting rails, behind at least a portion of at least one of such mounting rails and a combination thereof. Placing such back-board type member in a substantially upright position supported by such support means.

### OBJECTS OF THE INVENTION

It is, therefore, one of the primary objects of the present invention to provide a display device for displaying items such as escort cards, place cards, name tags, name badges, badges, seating arrangement cards, instructional cards, index cards, photographs, greeting cards, and the like.

Another object of the present invention is to provide a display device which may be stood substantially upright on an easel, stand, or leaned against a vertical structure and which conveniently holds in place items such as escort cards, place cards, name tags, name badges, badges, seating arrangement cards, instructional cards, index cards, photographs, greeting cards, and the like such that such items can be easily read and removed from such device.

Still another object of the present invention is to provide a device which can be used to aesthetically display escort cards, place cards, name tags, name badges, badges, seating arrangement cards, instructional cards, index cards, photographs, greeting cards, and the like in such a way that persons seeking to find a particular escort card, place card, name tag, name badge, badge, seating arrangement card, instructional card, index card, photograph, greeting card and the like, can find it quickly and, if desired, remove it quickly, such that a large number of people will require less time to find such items than if such items were laid out on a table or other surface.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3 is a partial perspective view of the invention according to one embodiment of the invention.

FIG. 4 is a partial perspective view of the invention according to one embodiment of the invention.

FIG. 5 is a partial perspective view of the invention according to one embodiment of the invention.

FIG. 6 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

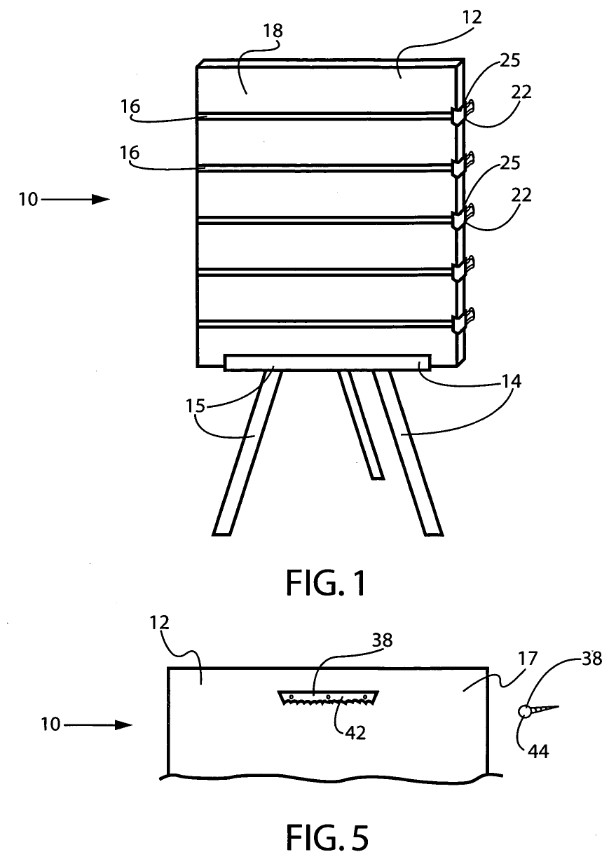

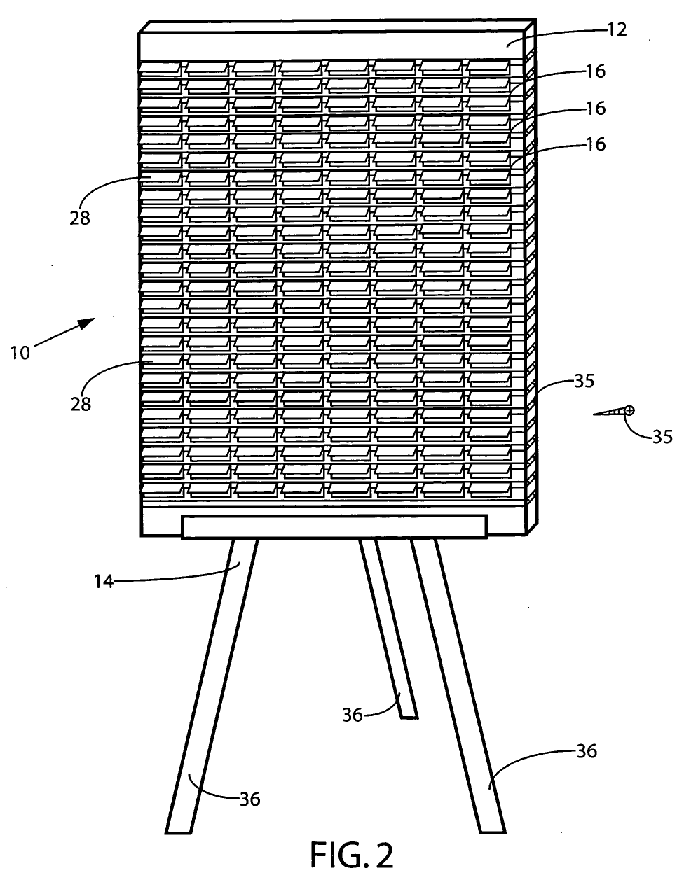

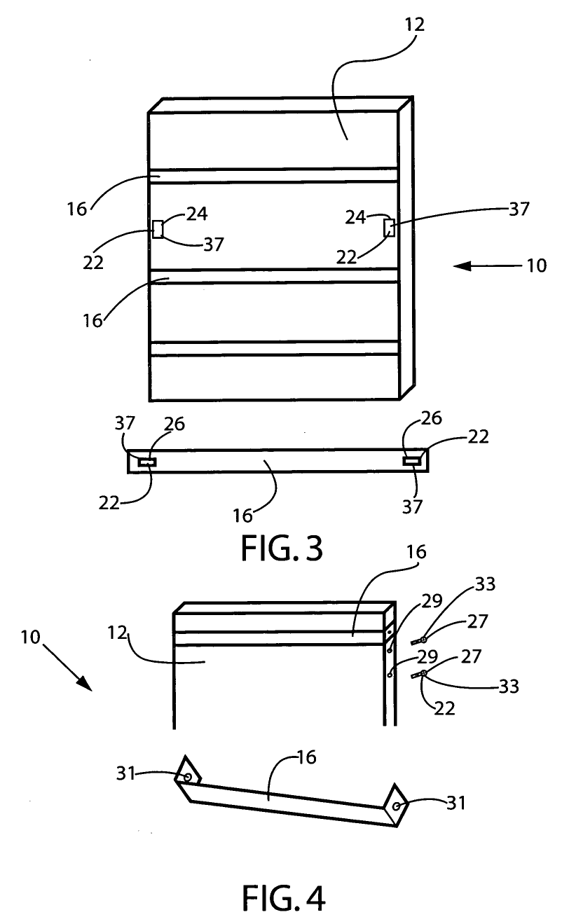

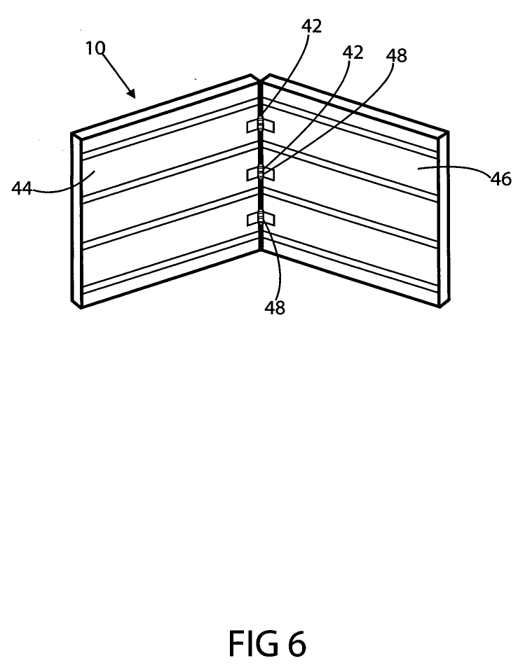

Reference is now made, more particularly, to FIGS. 1-6.

A display device, generally designated 10, is provided. Such display device 10 includes a back-board type member 12 manufactured from a first predetermined material and having a first predetermined shape and a first predetermined size.

It is presently preferred that such first predetermined material is at least one of wood, plastic, cardboard, metal and a combination thereof. It is presently most preferred that such first predetermined material is plastic.

It is presently preferred that such first predetermined shape is generally rectangular.

A support means 14 is engageable with such back-board type member 12 for supporting such back-board type member 12. It is presently preferred that such support means is an easel 15. It is presently preferred that such easel 15 is secured to such back board type member 12 at a predetermined location thereon adjacent a back side 17 of such back board type member 12. However, the device is not meant to be limited as such, and any type of support means may be utilized. Furthermore, it is contemplated that the device 10 be a size and shape that renders it self supporting. Moreover, the device 10 may be mounted to a wall, table, or the like, and it is also contemplated that such device may be suspended from a ceiling or other structure. It is also contemplated that such support means 14 be a pivotable leg type support means such as those found on the back of photo frames and the like such that the device 10 may be either placed flush against a wall or such support means 14 may be implemented to support such backboard type member 12.

A plurality of mounting rails 16 are releasably securable to such back-board type member 12 on at least one of a front side 18 of such backboard type member 12, a back side 17 of such backboard type member 12, and a combination thereof, such that each of such plurality of mounting rails 16 runs at least one of side to side and top to bottom across such back-board type member 12. Such mounting rails 16 are manufactured from a second predetermined material and have a second predetermined size and a second predetermined shape. It is worth noting that although it is presently preferred that such mounting rails 16 are releasably secured to such backboard type member 12, it is contemplated that such device 10 may be manufactured with such mounting rails 16 permanently secured to such backboard type member 12. Furthermore, it is meant that such mounting rails 16 may be securable to such backboard type member 12 at any location thereon which reasonably facilitates their purpose.

It is presently preferred that such second predetermined material is at least one of wood, plastic, cardboard, metal and a combination thereof. It is presently most preferred that such second predetermined material is plastic.

It is presently preferred that such second predetermined shape is at least one of generally round and generally rectangular. It is presently most preferred that such second predetermined shape is generally rectangular.

A securing means 22 has a first portion 24 engageable with such back-board type member 12 and a second portion 26 engageable with such plurality of mounting rails 16 for releasably securing such mounting rails 16 to such back-board type member 12 at a predetermined location thereon such that at least a predetermined portion of at least one predetermined item 28 may at least one of sit on at least a portion of at least one of such mounting rails 16, releasably slide behind at least a portion of at least one of such mounting rails 16 and a combination thereof.

It is meant that such display device 10 be used for displaying items as escort cards, place cards, name tags, name badges, badges, seating arrangement cards, instructional cards, index cards, photographs, greeting cards, favors, small gifts and the like. However, the device is not meant to be limited as such and such device may be used to display a wide variety of items as chosen by a user.

It is presently preferred that such securing means 22 is at least one of a clamp type securing means 25, a screw type securing means 35, a hook and loop type securing means 37, a snap type securing means (not shown), an adhesive type securing means (not shown), a bolt type securing means 27, and a combination thereof. It is presently most preferred that such securing means 22 is a clamp type securing means 25.

According to another embodiment, such securing means 22 is a bolt type securing means 27 and wherein such plurality of mounting rails 16 each include a plurality of apertures 31 disposed therethrough at predetermined location thereon and such back-board type member 12 further includes a plurality of threaded apertures 29 disposed therethrough at predetermined locations thereon, such apertures 31 and such threaded apertures 29 being alignable with each other for receiving a plurality of bolt type members 33.

Although the illustrations depict the mounting rails 16 being secured to sides of the backboard type member 12, it is also meant that such securing means 22 may attach to any portion of such backboard type member such as the front, back, sides, top, and bottom as desired.

According to still another embodiment such support means 14 includes a plurality of legs 36 operably disposed on such back-board type member 12 at a predetermined location thereon.

According to yet another embodiment, such support means includes a hanging means 38 having a first portion 42 operably disposed on a back side 17 of such back board type member 12 and a second portion 44 releasably securable to at least one of a wall, a ceiling, and a vertical structure for supporting such first portion 42 such that such display device 10 hangs from such at least one of such wall, such ceiling, and such vertical structure.

According to still another embodiment, such display device 10 according further includes a connecting means 42 for operably connecting a first display device 44 to at least a second display device 46. It is presently preferred that such connecting means 42 includes at least one hinge type connecting means 48. It is meant that two of such devices may be hinged together such that the devices may be folded together to allow for easy transport of such devices and to ensure items positioned on such display device will remain in position during travel.

According to another embodiment a method of displaying at least one of escort cards, place cards, name tags, name badges, badges, seating arrangement cards, instructional cards, index cards, photographs, greeting cards, and a combination thereof is provided. Such method includes the steps of providing a display device including; a back-board type member manufactured from a first predetermined material and having a first predetermined shape and a first predetermined size, a means engageable with such back-board type member for supporting such back-board type member, a plurality of mounting rails releasably securable to such back-board type member on at least one of a front side of such backboard type member, a backside of such backboard type member, and a combination thereof such that each of such plurality of mounting rails runs at least one of side to side and top to bottom across such back-board type member, such mounting rails being manufactured from a second predetermined material and having a second predetermined size and a second predetermined shape, a securing means having a first portion engageable with such back-board type member and a second portion engageable with such plurality of mounting rails for releasably securing such mounting rails to such back-board type member at a predetermined location thereon such that at least a predetermined portion of at least one predetermined item may at least one of sit on at least a portion of at least one of such mounting rails, releasably slide behind at least a portion of at least one of such mounting rails and a combination thereof. Placing at least a portion of at least one of such escort cards, such place cards, such name tags, such name badges, such badges, such seating arrangement cards, such instructional cards, such index cards, such photographs, such greeting cards and a combination thereof at least one of on at least a portion of at least one of such mounting rails, behind at least a portion of at least one of such mounting rails and a combination thereof. Placing such back-board type member in a substantially upright position supported by such support means.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A display device comprising:
a. a back-board type member manufactured from a first predetermined material and having a first predetermined shape and a first predetermined size;
b. a support means engageable with said back-board type member for supporting said back-board type member;
c. a plurality of mounting rails releasably securable to said back-board type member on at least one of a front side of said backboard type member, a backside of said backboard type member, and a combination thereof such that each of said plurality of mounting rails runs at least one of side to side and top to bottom across said back-board type member, said mounting rails being manufactured from a second predetermined material and having a second predetermined size and a second predetermined shape; and
d. a securing means having a first portion engageable with said back-board type member and a second portion engageable with said plurality of mounting rails for releasably securing said mounting rails to said back-board type member at a predetermined location thereon such that at least a predetermined portion of at least one predetermined item may at least one of sit on at least a portion of at least one of said mounting rails, releasably slide behind at least a portion of at least one of said mounting rails and a combination thereof.

2. A display device according to claim 1 wherein said first predetermined material is at least one of wood, plastic, cardboard, metal and a combination thereof.

3. A display device according to claim 2 wherein said first predetermined material is plastic.

4. A display device according to claim 1 wherein said second predetermined material is at least one of wood, plastic, cardboard, metal and a combination thereof.

5. A display device according to claim 1 wherein said second predetermined material is plastic.

6. A display device according to claim 1 wherein said securing means is at least one of a clamp type securing means, a screw type securing means, a hook and loop type securing means, a snap type securing means, an adhesive type securing means, a bolt type securing means, and a combination thereof.

7. A display device according to claim 6 wherein said securing means is a clamp type securing means.

8. A display device according to claim 6 wherein said securing means is a bolt type securing means and wherein such plurality of mounting rails each include a plurality of apertures disposed therethrough at predetermined locations thereon and such back-board type member further includes a plurality of threaded apertures disposed therethrough at predetermined locations thereon, such apertures and such threaded apertures being alignable with each other for receiving a plurality of bolt type members.

9. A display device according to claim 1 wherein said support means includes a hanging means having a first portion operably disposed on a back side of said back board type member and a second portion releasably securable to at least one of a wall, a ceiling, and a vertical structure for supporting said first portion such that said display device hangs from such at least one of such wall, such ceiling, and such vertical structure.

10. A display device according to claim 1 wherein said support means includes a plurality of legs operably disposed on said back-board type member at a predetermined location thereon.

11. A display device according to claim 1 wherein said support means is an easel.

12. A display device according to claim 11 wherein said easel is secured to said back board type member at a predetermined location thereon adjacent a back side of said back board type member.

13. A display device according to claim 1 wherein said first predetermined shape is generally rectangular.

14. A display device according to claim 1 wherein said second predetermined shape is at least one of generally round and generally rectangular.

15. A display device according to claim 14 wherein said second predetermined shape is generally rectangular.

16. A display device according to claim 1 wherein said device further includes a connecting means for operably connecting said device to at least a second display device.

17. A display device according to claim 16 wherein said connecting means includes at least one hinge type connecting means.

18. A method of displaying at least one of escort cards, place cards, name tags, name badges, badges, seating arrangement cards, instructional cards, index cards, photographs, greeting cards, and a combination thereof comprising the steps of:
a. providing a display device including:
i. a back-board type member manufactured from a first predetermined material and having a first predetermined shape and a first predetermined size;
ii. a support means engageable with said back-board type member for supporting said back-board type member;
iii. a plurality of mounting rails releasably securable to said back-board type member on at least one of a front side of said backboard type member, a backside of said backboard type member, and a combination thereof such that each of said plurality of mounting rails runs at least one of side to side and top to bottom across said back-board type member, said mounting rails being manufactured from a second predetermined material and having a second predetermined size and a second predetermined shape; and
iv. a securing means having a first portion engageable with said back-board type member and a second portion engageable with said plurality of mounting rails for releasably securing said mounting rails to said back-board type member at a predetermined location thereon such that at least a predetermined portion of at least one predetermined item may at least one of sit on at least a portion of at least one of said mounting rails, releasably slide behind at least a portion of at least one of said mounting rails and a combination thereof;
b. placing at least a portion of at least one of such escort cards, such place cards, such name tags, such name badges, such badges, such seating arrangement cards, such instructional cards, such index cards, such photographs, such greeting cards, and a combination thereof at least one of on at least a portion of at least one of said mounting rails, behind at least a portion of at least one of said mounting rails and a combination thereof; and
c. placing said back-board type member in a substantially upright position supported by said support means.
